(19) United States
(12) Patent Application Publication
(10) Pub. No.: US 2018/0018096 A1
(43) Pub. Date: Jan. 18, 2018

(54) BALANCED LOAD DISTRIBUTION FOR REDUNDANT DISK ARRAY

(71) Applicant: University of New Hampshire, Durham, NH (US)

(72) Inventors: András Krisztián Fekete, Fremont, NH (US); Elizabeth Varki, Lee, NH (US)

(73) Assignee: University of New Hampshire, Durham, NH (US)

(21) Appl. No.: 15/646,491

(22) Filed: Jul. 11, 2017

Related U.S. Application Data
(60) Provisional application No. 62/361,065, filed on Jul. 12, 2016.

(51) Int. Cl. G06F 3/06

(52) U.S. Cl. CPC G06F 3/064; G06F 3/0689; G06F 12/1009; G06F 3/0617; G06F 3/0665; G06F 2212/65

(57) ABSTRACT

A redundant disk array includes homogeneous or heterogeneous disks divided into chunks, where larger disks have more chunks. Chunks from one or more disks are grouped into bundles containing data stored across multiple disks. Frequently accessed chunks can be moved to under-utilized, faster disks and least frequently used chunks can be moved to larger, slower disks, to balance the distribution of load across all of the disks in the array.

### RELATED APPLICATION

This application claims the benefit of U.S. Provisional Patent Application Ser. No. 62/361,065, filed Jul. 12, 2016, which is hereby incorporated by reference in its entirety.

### FIELD OF THE DISCLOSURE

This disclosure relates to the field of electronic data storage devices, and more particularly, to a redundant disk array configuration that optimizes array disk space.

### BACKGROUND

RAID (Redundant Array of Independent or Inexpensive Disks) is a data storage virtualization technology that combines multiple physical disk drive components into a single logical unit for the purposes of data redundancy, performance improvement, or both. Some existing RAID configurations utilize homogeneous disks having equal physical capacity and speed. Thus, when a disk in a RAID array fails, it is typically replaced with a disk having a similar capacity and speed. However, due to advancements in technology, the storage capacity and access speed of disks are ever-increasing. Therefore, replacement disks can be larger and faster than the disks they are replacing in the RAID array. However, with existing techniques, a RAID array having disks of unequal capacity or speed is constrained by the capacity and speed of the smallest or slowest disk in the array. Thus, the additional capacity on larger disks is wasted, and the speed of the array is limited by the slowest component.

### BRIEF DESCRIPTION OF THE DRAWINGS

The accompanying drawings are not intended to be drawn to scale. In the drawings, each identical or nearly identical component that is illustrated in various figures is represented by a like numeral.

FIG. 1 shows an example RAID array.

FIG. 2A shows an example redundant disk array with three-disk redundancy, in accordance with an embodiment of the present disclosure.

FIG. 2B shows an example redundant disk array with two-disk redundancy, in accordance with an embodiment of the present disclosure.

FIG. 3 shows another example redundant disk array, in accordance with an embodiment of the present disclosure.

FIGS. 4A and 4B are flow diagrams of an example methodology for balanced load distribution for a redundant disk array, in accordance with embodiments of the present disclosure.

FIG. 5 is a block diagram representing an example computing device that can be used in accordance with an embodiment of the present disclosure.

### DETAILED DESCRIPTION

Overview

U.S. application Ser. No. 14/974,429, entitled “REDUNDANT DISK ARRAY USING HETEROGENEOUS DISKS” and filed on Dec. 18, 2015, is incorporated by reference herein in its entirety.

In overview, according to an embodiment of the present disclosure, a redundant disk array includes homogeneous or heterogeneous disks (also referred to as data storage devices) divided into chunks, where larger disks have more chunks than smaller disks. Chunks from one or more disks are grouped into bundles containing data stored across multiple disks. Frequently accessed chunks can be moved to under-utilized, faster disks and least frequently used chunks can be moved to larger, slower disks, to balance the distribution of load across all of the disks in the array.

When a RAID system has been set up with drives of equal size and a disk fails after several years of use, the failed disk can be replaced with another disk of similar capacity. However, it may not be possible or practical to purchase a replacement drive with the same capacity when a newer drive with twice the size is available. One problem with using a larger capacity replacement disk is that, with some existing RAID techniques, the capacity of the replacement disk that exceeds the capacity of the remaining disks in the array will be unusable and therefore wasted. Moreover, newer disks, including Solid State Disks (SSDs), often have higher access speeds. However, with some existing RAID techniques, the maximum speed of the array is limited to the speed of the slowest disk. As a result, the faster disks may be under-utilized.

To that end, disclosed herein are techniques for using heterogeneous disks of dissimilar storage capacities and access speeds in a redundant disk array, with less wastage of available storage and speed capacity, by taking advantage of the capacity and speed of each disk in the array. Furthermore, such techniques can be used to support growing the file-system while it is on-line. Embodiments of this disclosure further include techniques for increasing the total storage capacity of a redundant disk array with the addition of a heterogeneous disk and graceful degradation of total space in the event of a disk failure. Numerous configurations and variations will be apparent in view of the present disclosure.

Generally, a redundant disk array in accordance with an embodiment removes the predictability of where a block of data is stored on the physical disk. This comes at the cost of having to store a lookup table, but in relation to the size of storage that is available this cost is negligible. A benefit of this includes having a variable sized partition. A graceful degradation feature of this system allows the redundant disk array to exit from a degraded state by reorganizing the way data is stored on the disks for as long as it is possible to shrink the file-system on top of the array. With this feature, it is possible to lose another disk without catastrophic effects, which is not possible with existing RAID. Existing, conventional RAID can only rebuild what has been lost on the missing disk once a new disk has been added to the array.

Hard disk drives are notorious for being sensitive. Since they are mechanical devices, a great deal of care must be taken in their use and operation. Throughout the years, the storage density of drives has been increasing at a rate of 40% per year. Today, more and more data is stored, but the reliability of the drives remains substantially the same. What has changed is the time scale, which is measured by the Mean Time to Failure (MTTF) of a drive. Nowadays having a million hours before failure is typical for a drive, while 20 years ago it was about ten thousand hours. So not only are drives getting denser, but they are failing with less frequency. This is a good thing, but the failure rate isn't keeping up with the rate the capacity increases.

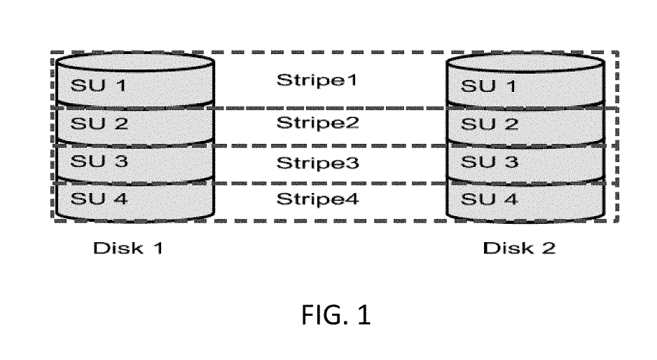

Some methods exist for combining the MTTF of multiple disks to decrease the likelihood of data loss, as well as speed up I/O operations, by combining the speed of drives together. This is generally referred to as Redundant Arrays of Inexpensive Disks (RAID). Most RAID concepts and techniques rely on the fact that all disks are identical (e.g., the disks have identical capacities). In some existing RAD configurations, each disk is split up into stripe units. The stripe units are generally based on the block size of a disk. Stripe units (e.g., SU1, SU2, SU3, SU4, etc.) are logical units of storage that share the same logical location across different disks or otherwise different storage devices are grouped into a stripe (e.g., Stripe1, Stripe2, Stripe3, Stripe4, etc.), as shown in FIG. 1. For example, as shown in FIG. 1, Stripe1 includes SU1 on both Disk 1 and Disk 2. Depending on the number of disks in the array, it is possible to achieve certain so-called RAD levels. The simplest level is RAID0 and RAID1 also known as striping and mirroring respectively. This is the simplest kind of RAID that can be implemented with as little as two drives. More advanced RAID levels are ones like RAID5 (single parity) and RAID6 (double parity). Parity refers to how redundant the algorithm is which determines how many disks can die before data loss occurs.

For some time, it has been understood that all disks in a redundant array are of the same size, or if different sizes are used, the total usable space is limited by the size of the smallest disk, with the excess capacity going to waste. This causes inefficient disk usage and causes problems when a disk in an array needs to be replaced, as the same model or size disk may not be available. A different layout scheme on heterogeneous disks can be used where the array uses a RAID5 topology until a disk fills up, then the remaining disks are used to continue allocating stripes of a RAID until all disks are full. However, this creates a complicated mechanism where a pseudo stripe pattern must be stored, where each stripe unit on the disk is located using a complex computation. In contrast to such existing techniques, a redundant disk array in accordance with an embodiment is a novel solution to using heterogeneous disks where logical restrictions on where a stripe unit is located are removed, while keeping the logical block mapping an O(1) problem.

Architecture

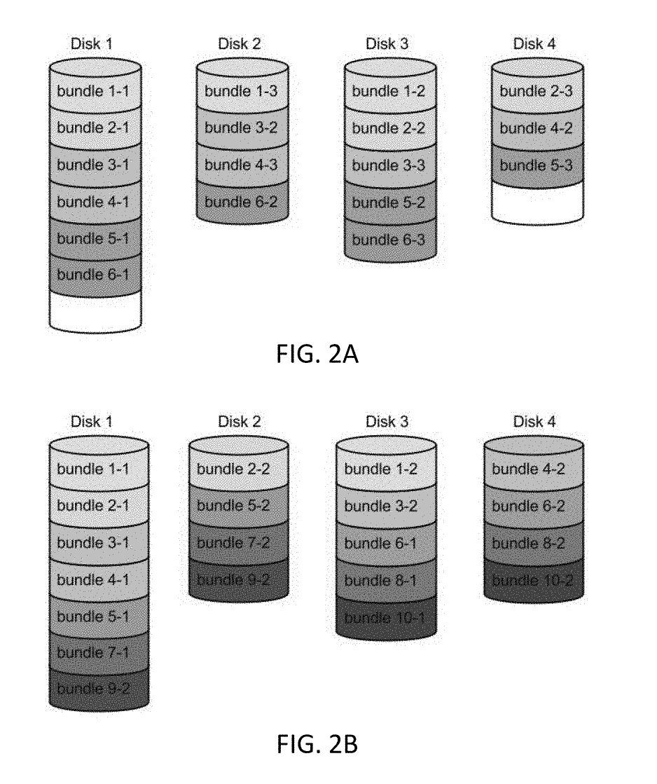

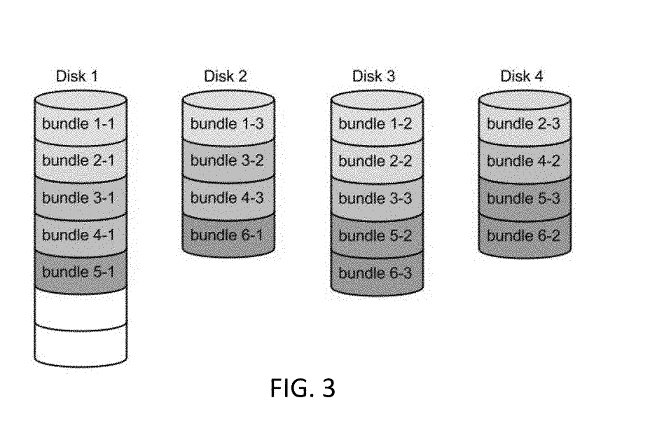

According to an embodiment of the present disclosure, a redundant disk array utilizes the concept of chunking. The array works by creating groupings of sequential logical blocks on a disk, called chunks. The number of chunks on a given disk depends on the storage capacity of the disk. Chunks are grouped into bundles. Each bundle includes at most one chunk from each disk of the array, and bundles of an array have the same number of chunks. In accordance with an embodiment, the chunks in a bundle can be scattered at different locations throughout the array (e.g., on different disks or otherwise different storage devices). For example, if there are two disks with two equally sized and similarly located chunks on each disk, a given bindle can include the first chunk on the first disk and the second chunk on the second disk. Each chunk in a bundle has related chunks stored on another disk in an arbitrary location to ensure that if a disk fails, the failure does not destroy more than one chunk in one bundle. Chunks can be paired anywhere on the disk, whereas stripe units are determined based on physical location. For example, as shown in FIG. 2A, and in accordance with an example embodiment of the present disclosure, each bundle can include multiple chunks from different disks. In this example, Bundle 1 includes a first chunk (labeled B1: B1-1, B1-2, B1-3) from Disk 1 (B1-1), Disk 3 (B1-2), and Disk 2 (B1-3); Bundle 2 includes a second chunk (labeled B2: B2-1, B2-2, B2-3) from Disk 1 (B2-1), Disk 3 (B2-2), and Disk 4 (B2-3); Bundle 3 includes a third chunk (labeled B3: B3-1, B3-2, B3-3 from Disk 1 (B3-1), Disk 2 (B3-2), and Disk 3 (B3-3); and so on. In this example, each bundle has three chunks, but it will be understood that generally bundles can include two or more chunks, as long as every bundle in the array has the same number of chunks. For example, FIG. 2B shows a redundant disk array with two chunks per bundle, in accordance with another example embodiment of the present disclosure. Generally, label Bx-y represents the y^{th} chunk from bundle number x. A bundle is conceptually similar to a stripe, but bundles and stripes are structurally different. For example, unlike conventional stripes, the number of chunks in a bundle can be less than the number of disks in the array, chunks of a bundle need not be at identical locations on each disk, and two bundles can contain chunks located on different sets of disks within the array.

A redundant disk array in accordance with an embodiment can allow two types of redundancy: parity and copy. With parity-type redundancy, each bundle includes a parity chunk. For instance, the redundant disk array of FIG. 2B can be parity-type with three or more chunks in a bundle. In this example, the third chunk of each bundle can be the parity chunk. With copy-type redundancy, each bundle includes a chunk and its mirror. For instance, the redundant disk array of FIG. 2B can be copy-type, where each bundle includes two identical chunks—a chunk and its mirror.

In accordance with an embodiment, two input parameters are: 1) the size of a chunk and 2) the number of chunks in a bundle. Some of the factors that determine the size of a stripe unit are relevant to determining the size of a chunk. A chunk size can be, for example, 4 KB, 8 KB, 16 KB, 64 KB, 256 KB, or greater (similar to selection of stripe unit sizes).

The number of chunks in a bundle, referred to as bundle length L, can be a minimum of one and a maximum of D, which is the number of disks in the array. The allocation of chunks to bundles has more options when the value of L is small. The smallest L value depends on the redundancy level. For example, in a parity-type array, L=3; in a copy-type array, L=2; in a non-redundant array, L=1. There are at least three cases: L=1, L=D, 1<L<D.

In the case where there is one chunk per bundle (L=1), the number of bundles on each disk is equal to the number of chunks on the disk (given by the disk's size divided by chunk size). This level of chunks per bundle provides maximum capacity and no redundancy. The number of bundles, B, in the array is equal to the sum of number of chunks on all of the disks. The bundles can, for example, be numbered as follows: Bundle 1 (B1-1) includes a first chunk on Disk 1, B2-1 includes first chunk on Disk 2, B3-1 includes first chunk on Disk 3, and so on.

In the case where there are D chunks per bundle (L=D), D is the number of disks in the array. Here, the number of bundles in the array, B, is equal to the number of chunks on the smallest disk in the array. Each bundle includes one chunk from each disk in the array.

In the case where 1<L<D, the bundle length is greater than one but less than the number of disks in the array. There are different strategies for assigning chunks to bundles. For example, an allocation strategy that maximizes utilization of all disks can include calculating the maximum number of chunks for each disk (disk size divided by chunk size minus the number of chunks the lookup table occupies). Initially, all chunks are not assigned to any bundle. Bundle to chunk assignment can occur as follows: B1 is assigned chunks from the L disks with greatest number of non-assigned chunks; next B2 is assigned chunks from the L disks with the greatest number of remaining unassigned chunks, and so on, until there is no space for further complete bundle assignment. For example, consider FIG. 2A where L=3, and FIG. 2B where L=2. In FIG. 2A, B1 includes chunks from the three disks (D1, D2, D3) with maximum unassigned chunks; B2 includes chunks from the three disks (D1, D3, D4) with the maximum remaining unassigned chunks, and so on. In FIG. 2B, B1 includes chunks from the disks with the maximum number of unassigned chunks (D1, D3); B2 includes chunks from the disks with the maximum number of remaining unassigned chunks (D1, D2), and so on.

The number of bundles in an array, B, is inversely proportional to the bundle length L. In FIG. 2A, B=6; in FIG. 2B, B=10. The degree of parallelism is directly proportional to the bundle length, and L=D results in maximum parallelism. Reconsider FIGS. 2A and 2B: L=4 with chunks bundled across all disks have parallelism of 4. However, L=2, can also result in maximum parallelism depending on how bundles are assigned to chunks. For example, suppose B1 is assigned to chunks from D1, D2, and B2 is assigned to chunks from D3, D4, and assignment continues in this manner. This degree of parallelism is determined both by the bundle length and the bundle allocation policy.

The redundancy level of a copy-type array depends on the bundle length L. L=2 gives a single disk redundancy, whereas L=3 gives dual disk redundancy, and so on. For a parity-type array, the larger the bundle length L, the lesser the disk space wasted by parity and the longer the rebuild process upon single disk failure. This can be illustrated, for example, by ten disks of identical size. If L=3 (the minimum necessary for a parity-type array), then ⅓^{rd} of the total storage space is used for parity, but only L−1=2 disks, are read during the rebuild process. Now consider L=10: only 1/10^{th} of the storage space is used by parity, but L−1=9 disks are read during the rebuild process.

Lookup Table

With a redundant disk array in accordance with an embodiment, a lookup table is stored in random access memory (RAM) or another suitable data store. The lookup table is a map between the physical location (e.g., physical disk block) of each disk chunk and the logical location of each disk chunk. The lookup table can be an array whose size is bounded by the number of chunks on the drive, and thus the lookup table can be an O(1) lookup. The size of a chunk can, for example, be 4096 bytes or some multiple of that number as per the standard put forth by IDEMA (International Disk Drive Equipment and Materials Association) makes that be the most efficient size to transfer on today's drives, although other chunk sizes are possible. The size of the chunk also determines the amount of RAM that will be used, but having a large chunk size may affect the efficiency at which small fragmented data can be accessed. The smaller chunk size is good for quick access to small files, but a larger chunk size allows for better throughput.

In RAID, stripe numbers are assigned to stripe units implicitly: stripe 1 includes the first stripe unit from each disk, stripe 2 includes the second stripe unit from each disk, and stripe i includes of the i^{th} stripe unit from each disk. By contrast, in accordance with an embodiment of the present disclosure, bundle numbers can be assigned to chunks by a bundle allocation strategy, so a data structure that explicitly maps bundle numbers to chunks is required. The chunks in bundle i (Bi) can be found by using a lookup table that maps bundle numbers to disk numbers and to the chunk number within the disk.

In accordance with an embodiment, each disk has an associated array that maps chunk numbers to bundle numbers. In FIG. 2A, disk 1's lookup array, D1-lookup is as follows: c[1]=1, c[2]=2, c[3]=3, c[4]=4, c[5]=5, c[6]=6, c[7]=0. The last chunk of D1 is not assigned to any bundle, so c[7] is set to 0. Disk 2's lookup array, D2-lookup, is as follows: c[1]=1, c[2]=3, c[3]=4, c[4]=6. Disk 3's lookup array, D3-lookup, is as follows: c[1]=1, c[2]=2, c[3]=3, c[4]=5, C[5]=6. Disk 4's lookup array, D4-lookup, is as follows: c[1]=2, c[2]=4, c[3]=5, c[4]=0.

At boot time, a bundle-lookup table can be constructed from the disk-lookup arrays; for example, the bundle-lookup table maps bundle numbers to chunk addresses. The lookup associated with FIG. 2A is as follows. Bundle 1 is mapped to the first chunk in disks 1, 3, 2, so it can be written as: b[1]=[(1,1),(3,1),(2,1)], where (1,1) refers to disk 1, chunk 1; (2,1) refers to disk 2, chunk 1; (3,1) refers to disk 3 chunk 1. Similarly, for bundle 2, b[2]=[(1,2),(3,2),(4,1)], bundle 3, b[3]=[(1,3),(2,1),(3,3)], and so on. Every request arriving at a redundant array in accordance with an embodiment can be mapped to the correct disk location via the lookup table.

Performance Tuning

In a redundant array of disks having different sizes and speeds, the array may be considered unbalanced. For example, data can be bundled across the heterogeneous disks of the array. A request that is bundled across several disks is completed only when all its chunks are read or written. Therefore, performance can be maximized by balancing the load across the disks in the array. An objective is to minimize the average response time of the array. An example strategy to lower response time of a multiple server system is the following: an arriving job should be directed to a faster server if the system is idle; on the other hand, an arriving job should be directed to an idle slower server if the faster servers are busy. However, requests can only be serviced from the disk on which the data resides. A larger disk that has more chunks may, therefore, get a proportionally larger number of requests. Similarly, slower disks may have more outstanding requests waiting in the queue than faster disks.

The inherent variance in sizes and speeds of disks in a redundant array of an example embodiment can result in an unbalanced load, with some disks being under-utilized while other disks may cause performance bottlenecks. To prevent disk bottlenecks, the workload to the disks may be configured such that faster disks get proportionally more read/write requests.

It will be appreciated that under-utilized disks are not necessarily the fastest disks. If all frequently accessed data are moved to the faster disks, then these faster disks may become the bottleneck when arrival rates increase. As such, the workload of individual disks can be variable as the arrival rates and the data access patterns change over time. To this end, and in accordance with an embodiment of the present disclosure, a performance tuner is configured to address 1) tracking disk utilization, 2) shuffling (moving) storage data between disks, and 3) tracking frequently accessed chunks.

Disk Utilization

Disk utilization is a measure of a disk's busy time—the proportion of busy time over total running time. If all the disks in a redundant array contained identical data, then an arriving request can be directed to the disk with no outstanding requests, or to an SSD with a short queue. The SSD is an order of magnitude faster than the HDD, so an SSD with a short queue of outstanding requests can service an arriving request faster than an idle HDD. To balance load, the load is measured at each disk when a request arrives at the array. Arrival instant disk utilization can, for example, be estimated from arrival instant queue lengths. Each time a request is submitted to the array, the number of outstanding requests at each disk is recorded, a moving average of arrival instant queue lengths is calculated.

The disk with the greatest queue length is considered a bottleneck, and frequently accessed chunks from this disk should be moved to disks with smaller queue lengths. If the average arrival instant queue length of all disks is close to zero, then frequently accessed data can be moved to the fastest disk; if not, frequently accessed data can be moved to under-utilized disks.

In some cases, the arrival queue length can be equal among all disks. This can happen, for example, when requests are small and do not require the use of all the disks in the array. In this case, the estimated disk speed can be obtained by observing the size of the request divided by the amount of time the request takes to complete. We look at reads and writes separately as SSDs have a much faster read, but may not exhibit a significantly faster write because of the large memory caches placed on HDDs.

Shuffling Chunks Between Disks

In accordance with an embodiment of the present disclosure, data can be bundled across multiple disks. Each bundle spans L disks of the array. It is possible that an entire bundle is frequently accessed. It is also possible that a particular chunk within a bundle is frequently accessed. When all the chunks of a bundle are frequently accessed, then the entire bundle can be moved to one or more lesser-utilized disks in the array. When a chunk is frequently accessed, only the chunk in the bundle needs to be moved. Therefore, it is possible to move storage data without updating logical block numbers. For instance, data can be moved by moving the corresponding chunks and bundles where the data are stored. When chunks and bundles are moved, the lookup table and the associated disk-lookup arrays are updated. Changing the address of chunks and bundles does not impact the logical block numbers since the file system maps to the same bundle.

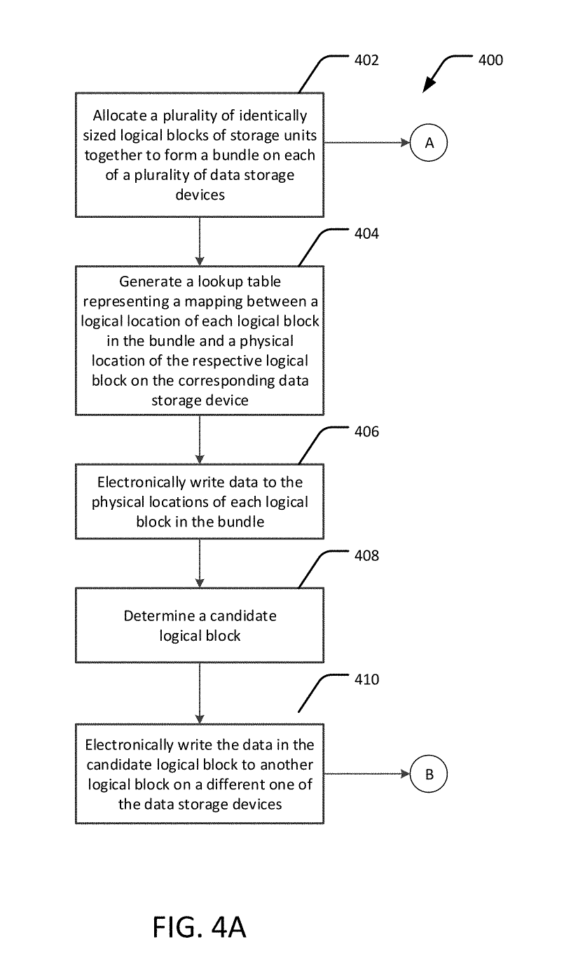

For example, FIG. 3 shows an example where the array of FIG. 2A with chunk B6-2 of Bundle 6 (b[6]=[(1,6), (2,4),(3,5)]) has been moved to a faster Disk 4. This change can be updated in the lookup table as: b[6]=[(1,6),(4,4),(3,5)]. Suppose Disk 1 is the bottleneck and chunk B6-1 is frequently accessed; if Disk 2 is under-utilized, the chunk B6-1 on Disk 1 can be moved onto Disk 2, so that b[6]=[(2,4),(4,4),(3,5)]. The corresponding changes are also made in the disk-lookup arrays.

Thus, in accordance with an embodiment, data can be moved between disks by shuffling chunk addresses. The shuffling of chunks and bundles can be an atomic (all-or-nothing) operation. Initially, all disks in the array will have free (unallocated) chunks used as temporary chunks for shuffling. A chunk can be moved to an unused chunk. This ensures atomicity as the chunk is not considered moved until the lookup table is updated. The shuffling can occur during idle time. If a request arrives during shuffling, the shuffling stops and the request is serviced.

Tracking Chunk Access Frequency

In accordance with an embodiment of the present disclosure, an imbalance in a redundant disk array can be reduced or eliminated by altering the workload on the individual disks so that more requests are serviced by faster disks. For example, frequently accessed chunks can be moved to faster disks, and less frequently accessed chunks can be moved to larger, slower disks by tracking the rates at which individual chunks are accessed.

RAIDX uses the frequency of access of a chunk to determine the chunk's placement on disk. This is similar to how cache replacement algorithms determine what data should remain in cache and what data should be evicted. Cache replacement policies such as LRU (Least Recently Used) and LFU (Least Frequently Used) evict blocks from the cache. RAIDX uses similar algorithms to determine chunk placement on disk.

In accordance with an embodiment, the Most Frequently Used (MFU) chunks of the array can be tracked. When there is a lull in array traffic, chunk shuffling begins by moving the most frequently accessed chunk from a bottleneck disk to an under-utilized faster disk. If the faster disk is full, then the least frequently used chunk on the fast disk is swapped out. During chunk shuffling, the algorithm checks that there is at most one chunk from a bundle on each disk.

Example Performance Tuner

In an example embodiment, an approximate LFU algorithm can be used for estimating the most frequently used chunks and the least frequently used chunks on a disk. There can be two separate lookup tables: one on disk and one in RAM. Both tables are relatively small compared to the size of the storage. The performance tuner can be called when the system is idle. To help get the system up and running, additional reads are created to better estimate disk speeds. The performance tuner can periodically run a disk scrub, since deterministic disk scrubbing is an efficient and reliable method to avoid unrecoverable sector errors. In addition to disk scrubbing the performance tuner flushes dirty caches to disk.

Most of the workload in the performance tuner is in the movement of chunks based on the average access interval of each respective chunk (logical block). Each section of the performance tuner is timed, and if it has been running for more than, e.g., 50 milliseconds, outstanding system requests for data are executed, and the performance tuner is called, e.g., one second after the last request has completed. Otherwise, if there are no outstanding requests, the performance tuner is called again.

The disks can be grouped by speed and average queue length into disk groups. Each disk group contains L disks. The shuffling algorithm, which moves chunks between disks, is activated during lull periods. The shuffling algorithm pops an arbitrary element from the MFU set. The algorithm recalculates what the average access interval of the chunk would be if the element was accessed. If this interval is appropriate for the disk group that it is in, then the next element on the MFU set is popped. When a MFU element is in a slower disk group, then it is moved onto the appropriate faster disk group. If there is no free chunk in a faster disk group, then the least frequently accessed chunk is selected from a subset of all chunks on a disk in the group to be moved to a slower disk group. It is not necessary to find the absolute least frequently accessed chunk because it can vary as the system is being used. An approximate chunk selection yields a fast routine while the chunk layout approaches the optimal layout.

Example Lookup Table

In accordance with an embodiment, each chunk can store at least two items of information: 1) the disk the chunk resides on, and 2) the location offset of the chunk on the disk. In some embodiments, the chunk can also store 3) the last access time of the chunk, 4) the average access interval of the chunk, or both, although these items are not necessarily used in some embodiments and require additional memory when implemented. In some embodiments, a chunk data structure has a size of 15. Each chunk entry can include, for example, an 8 byte chunk offset on the disk, a 4 byte previous access time, a 2 byte average access interval, and a 1 byte disk ID. A 64 bit chunk offset is sufficient to support a 2048 petabyte array. The previous access time can be stored as a C++ std::chrono:timepoint using a 32 bit container, which is sufficient to store time at a resolution of minutes. The average access interval is a 16 bit integer that stores the average time between updates to the last access time. The larger the interval, the less often the chunk is accessed. When the average access interval changes by a significant amount, the chunk ID is placed in an unsorted set so that during the next cycle of the performance tuner will move the chunk to a faster disk. At boot time, this unsorted set will be empty. As chunks are accessed, the set is updated.

Upon initialization for each chunk entry, the offset field is populated based on the location of the chunk and the last access time is set to the current time. The other two fields are left as the maximum value for the field.

The selection of a chunk size can be similar to that of conventional RAID. The smaller chunk size creates more chunks which is better for systems with smaller files but slower for larger files. Larger chunk sizes also require less RAM to store the lookup table. The smallest chunk size can be, for example, 4 KB. Many filesystems use this as the minimum as well because the sector size of a drive has been set at 4 KB since 2011. In the worst case with 4 KB chunk sizes, using the equation above, the largest lookup table will be only 0.36% of the total physical storage space.

The lookup table can be stored on the physical storage and loaded into RAM upon startup. Each drive stores the information about those chunks that are stored on the device. The lookup table stored in RAM can have the chunks and bundles in an array so lookup is an O(1) operation. Once the array is assembled in RAM, there is no addition or removal of bundles in the course of normal operation.

An array of free chunk locations is stored for each disk in the array. This helps determine which disks can store chunks. The system overall will have as many free chunks as there are disks in the system. Over time, the free chunks tend to be on the slowest disks in the array.

Example Methodology

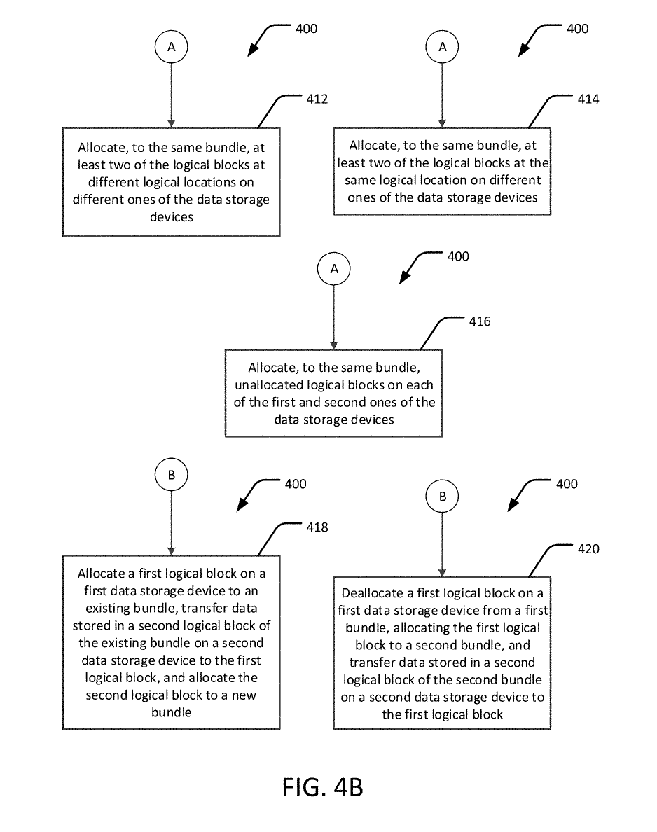

FIGS. 4A and 4B are flow diagrams of an example methodology 400 for balanced load distribution for a redundant disk array, in accordance with embodiments of the present disclosure. Referring to FIG. 4A, the methodology 400 includes allocating 402 a plurality of identically sized logical blocks of storage units together to form a bundle on each of a plurality of data storage devices, where at least two of the logical blocks in the bundle are located on different data storage devices. The methodology 400 further includes generating 404 a lookup table representing a mapping between a logical location of each logical block in the bundle and a physical location of the respective logical block on the corresponding data storage device, and electronically writing 406 data to the physical locations of each logical block in the bundle, where the physical locations are obtained from the lookup table. The methodology 400 further includes determining 408 fa candidate logical block among all of the logical blocks based at least in part on a speed of a different data storage device and an average access interval of the logical block on the different data storage device, and electronically writing 410 the data in the candidate logical block to another logical block on the different one of the data storage devices. In some embodiments, the candidate logical block is a most frequently accessed one of the logical blocks, or a least recently used one of the logical blocks.

In some embodiments, at least two of the data storage devices are heterogeneous, where at least two of the data storage devices have a different total number of logical blocks. In some other embodiments, at least two of the data storage devices are homogeneous, where at least two of the data storage devices have a same total number of logical blocks. In some such embodiments, at least one of the data storage devices has a different total number of logical blocks than another one of the data storage devices.

In some embodiments, such as shown in FIG. 4B, the methodology 400 includes allocating 412, to the same bundle, at least two of the logical blocks at different logical locations on different ones of the data storage devices.

In some embodiments, such as shown in FIG. 4B, the methodology 400 includes allocating 414, to the same bundle, at least two of the logical blocks at the same logical location on different ones of the data storage devices.

In some embodiments, such as shown in FIG. 4B, a first one of the data storage devices has a greatest number of logical blocks that are not allocated to any bundle among all of the data storage devices, and a second one of the data storage devices has a fewer number of logical blocks that are not allocated to any bundle among all of the data storage devices than the number of logical blocks that are not allocated to any bundle on the first data storage device. In such embodiments, the methodology 400 includes allocating 416, to the same bundle, unallocated logical blocks on each of the first and second ones of the data storage devices.

In some embodiments, such as shown in FIG. 4B, the methodology 400 includes allocating 418 a first logical block on a first data storage device to an existing bundle, transferring data stored in a second logical block of the existing bundle on a second data storage device to the first logical block, and allocating the second logical block to a new bundle. This can be done, for example, to transfer the data to another disk when the disk originally storing the data fails or is otherwise being removed from the array.

In some embodiments, such as shown in FIG. 4B, the methodology 400 includes deallocating 420 a first logical block on a first data storage device from a first bundle, allocating the first logical block to a second bundle, and transferring data stored in a second logical block of the second bundle on a second data storage device to the first logical block. This can be done, for example, to transfer the data to another disk when the disk originally storing the data fails or is otherwise being removed from the array.

Example Computing Device

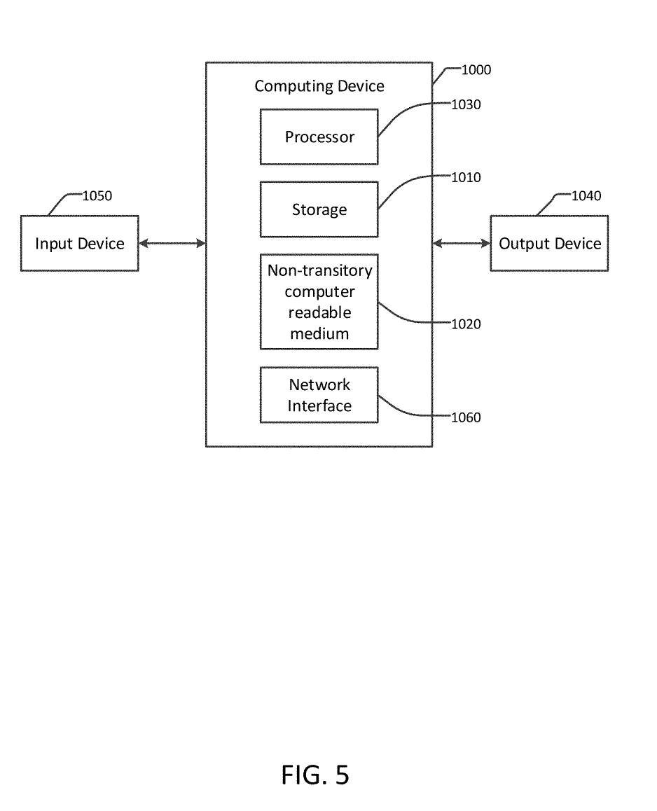

FIG. 5 is a block diagram representing an example computing device 1000 that can be used to perform any of the techniques as variously described in this disclosure. For example, any of the algorithms disclosed herein can be implemented in the computing device 1000, including the methodology 400 of FIGS. 4A and 4B. The computing device 1000 can be any computer system, such as a workstation, desktop computer, server, laptop, handheld computer, tablet computer (e.g., the iPad™ tablet computer), mobile computing or communication device (e.g., the iPhone™ mobile communication device, the Android™ mobile communication device, and the like), or other form of computing or telecommunications device that is capable of communication and that has sufficient processor power and memory capacity to perform the operations described in this disclosure. A distributed computational system can be provided comprising a plurality of such computing devices.

The computing device 1000 includes one or more data storage devices 1010 and/or non-transitory computer-readable media 1020 having encoded thereon one or more computer-executable instructions or software for implementing techniques as variously described in this disclosure. The storage devices 1010 can include a computer system memory or random access memory, such as a durable disk storage (which can include any suitable optical or magnetic durable storage device, e.g., RAM, ROM, Flash, USB drive, or other semiconductor-based storage medium), a hard-drive, CD-ROM, or other computer readable media, for storing data and computer-readable instructions and/or software that implement various embodiments as taught in this disclosure. The storage device 1010 can include other types of memory as well, or combinations thereof. FIGS. 1-3 show examples of such data storage devices 1010 in several combinations and configurations, according to various embodiments. The storage device 1010 can be provided on the computing device 1000 or provided separately or remotely from the computing device 1000. The non-transitory computer-readable media 1020 can include, but are not limited to, one or more types of hardware memory, non-transitory tangible media (for example, one or more magnetic storage disks, one or more optical disks, one or more USB flash drives), and the like. The non-transitory computer-readable media 1020 included in the computing device 1000 can store computer-readable and computer-executable instructions or software for implementing various embodiments. The computer-readable media 1020 can be provided on the computing device 1000 or provided separately or remotely from the computing device 1000.

The computing device 1000 also includes at least one processor 1030 for executing computer-readable and computer-executable instructions or software stored in the storage device 1010 and/or non-transitory computer-readable media 1020 and other programs for controlling system hardware. Virtualization can be employed in the computing device 1000 so that infrastructure and resources in the computing device 1000 can be shared dynamically. For example, a virtual machine can be provided to handle a process running on multiple processors so that the process appears to be using only one computing resource rather than multiple computing resources. Multiple virtual machines can also be used with one processor.

A user can interact with the computing device 1000 through an output device 1040, such as a screen or monitor, which can display one or more user interfaces provided in accordance with some embodiments. The output device 1040 can also display other aspects, elements and/or information or data associated with some embodiments. The computing device 1000 can include other I/O devices 1050 for receiving input from a user, for example, a keyboard, a joystick, a game controller, a pointing device (e.g., a mouse, a user's finger interfacing directly with a display device, etc.), or any suitable user interface. The computing device 1000 can include other suitable conventional I/O peripherals. The computing device 1000 can include and/or be operatively coupled to various suitable devices for performing one or more of the functions as variously described in this disclosure.

The computing device 1000 can run any operating system, such as any of the versions of Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device 1000 and performing the operations described in this disclosure. In an embodiment, the operating system can be run on one or more cloud machine instances.

In other embodiments, the functional components/modules can be implemented with hardware, such as gate level logic (e.g., FPGA) or a purpose-built semiconductor (e.g., ASIC). Still other embodiments can be implemented with a microcontroller having a number of input/output ports for receiving and outputting data, and a number of embedded routines for carrying out the functionality described in this disclosure. In a more general sense, any suitable combination of hardware, software, and firmware can be used, as will be apparent.

As will be appreciated in light of this disclosure, various modules and components can be implemented in software, such as a set of instructions (e.g., HMTL, XML, C, C++, object-oriented C, JavaScript, Java, BASIC, etc.) encoded on any computer readable medium or computer program product (e.g., hard drive, server, disc, or other suitable non-transient memory or set of memories), that when executed by one or more processors, cause the various methodologies provided in this disclosure to be carried out. As used in this disclosure, the terms “non-transient” and “non-transitory” exclude transitory forms of signal transmission. It will be appreciated that, in some embodiments, various functions performed by the user computing system, as described in this disclosure, can be performed by similar processors and/or databases in different configurations and arrangements, and that the depicted embodiments are not intended to be limiting. Various components of this example embodiment, including the computing device 1000, can be integrated into, for example, one or more desktop or laptop computers, workstations, tablets, smart phones, game consoles, set-top boxes, or other such computing devices. Other componentry and modules typical of a computing system, such as processors (e.g., central processing unit and co-processor, graphics processor, etc.), input devices (e.g., keyboard, mouse, touch pad, touch screen, etc.), and operating system, are not shown but will be readily apparent.

The foregoing description and drawings of various embodiments are presented by way of example only. These examples are not intended to be exhaustive or to limit the invention to the precise forms disclosed. Alterations, modifications, and variations will be apparent in light of this disclosure and are intended to be within the scope of the invention as set forth in the claims.

What is claimed is:

1. A computer-implemented method comprising:
allocating, by a processor, a plurality of identically sized logical blocks of storage units together to form a bundle on each of a plurality of data storage devices, at least two of the logical blocks in the bundle being located on different data storage devices;
generating, by the processor, a lookup table representing a mapping between a logical location of each logical block in the bundle and a physical location of the respective logical block on the corresponding data storage device;
electronically writing, by the processor, data to the physical locations of each logical block in the bundle, the physical locations being obtained from the lookup table;
determining, by the processor, a candidate logical block among all of the logical blocks based at least in part on a speed of a different data storage device and an average access interval of the logical block on the different data storage device; and
electronically writing, by the processor, the data in the candidate logical block to another logical block on the different one of the data storage devices.

2. The method of claim 1, wherein at least two of the data storage devices are heterogeneous, and wherein at least two of the data storage devices have a different total number of logical blocks.

3. The method of claim 1, wherein at least two of the data storage devices are homogeneous, and wherein at least two of the data storage devices have a same total number of logical blocks.

4. The method of claim 3, wherein at least one of the data storage devices has a different total number of logical blocks than another one of the data storage devices.

5. The method of claim 1, further comprising allocating, by the processor to the same bundle, at least two of the logical blocks at different logical locations on different ones of the data storage devices.

6. The method of claim 1, further comprising allocating, by the processor to the same bundle, at least two of the logical blocks at the same logical location on different ones of the data storage devices.

7. The method of claim 1, wherein the candidate logical block is one of a most frequently accessed one of the logical blocks and a least recently used one of the logical blocks.

8. The method of claim 1,
wherein a first one of the data storage devices has a greatest number of logical blocks that are not allocated to any bundle among all of the data storage devices;
wherein a second one of the data storage devices has a fewer number of logical blocks that are not allocated to any bundle among all of the data storage devices than the number of logical blocks that are not allocated to any bundle on the first data storage device; and
wherein the method further comprises allocating, by the processor to the same bundle, unallocated logical blocks on each of the first and second ones of the data storage devices.

9. The method of claim 1, further comprising
allocating, by the processor, a first logical block on a first data storage device to an existing bundle;
transferring, by the processor, data stored in a second logical block of the existing bundle on a second data storage device to the first logical block; and
allocating, by the processor, the second logical block to a new bundle.

10. The method of claim 1, further comprising
deallocating, by the processor, a first logical block on a first data storage device from a first bundle;
allocating, by the processor, the first logical block to a second bundle; and
transferring, by the processor, data stored in a second logical block of the second bundle on a second data storage device to the first logical block.

11. A system comprising:
a storage; and
a computer processor operatively coupled to the storage, the computer processor configured to execute instructions stored in the storage that when executed cause the computer processor to carry out a process comprising
allocating a plurality of identically sized logical blocks of storage units together to form a bundle on each of a plurality of data storage devices, at least two of the logical blocks in the bundle being located on different data storage devices;
generating a lookup table representing a mapping between a logical location of each logical block in the bundle and a physical location of the respective logical block on the corresponding data storage device;
electronically writing data to the physical locations of each logical block in the bundle, the physical locations being obtained from the lookup table;
determining, by the processor, a candidate logical block among all of the logical blocks based at least in part on a speed of a different data storage device and an average access interval of the logical block on the different data storage device; and
electronically writing, by the processor, the data in the candidate logical block to another logical block on the different one of the data storage devices.

12. The system of claim 11, wherein at least two of the data storage devices are heterogeneous, and wherein at least two of the data storage devices have a different total number of logical blocks.

13. The system of claim 11, wherein at least two of the data storage devices are homogeneous, and wherein at least two of the data storage devices have a same total number of logical blocks.

14. The method of claim 13, wherein at least one of the data storage devices has a different total number of logical blocks than another one of the data storage devices.

15. The system of claim 11, wherein at least two of the logical blocks in the same bundle are at different logical locations on different ones of the data storage devices.

16. The system of claim 11, wherein at least two of the logical blocks in the same bundle are at the same logical location on different ones of the data storage devices.

17. The system of claim 11,
wherein a first one of the data storage devices has a greatest number of logical blocks that are not allocated to any bundle among all of the data storage devices;
wherein a second one of the data storage devices has a fewer number of logical blocks that are not allocated to any bundle among all of the data storage devices than the number of logical blocks that are not allocated to any bundle on the first data storage device; and
wherein at least two logical blocks in the same bundle are allocated from unallocated logical blocks on each of the first and second ones of the data storage devices.

18. The system of claim 11, wherein the process includes allocating a first logical block on a first data storage device to an existing bundle;
transferring data stored in a second logical block of the existing bundle on a second data storage device to the first logical block, the second data storage device being different from the first storage device; and
allocating the second logical block to a new bundle.

19. The system of claim 11, wherein the process includes
deallocating a first logical block on a first data storage device from a first bundle;
allocating the first logical block to a second bundle; and
transferring data stored in a second logical block of the second bundle on a second data storage device to the first logical block, the second data storage device being different from the first storage device.

20. A non-transitory computer program product having instructions encoded thereon that when executed by one or more processors cause a process to be carried out, the process comprising:
allocating, by the one or more processors, a plurality of identically sized logical blocks of storage units together to form a bundle on each of a plurality of data storage devices, at least two of the logical blocks in the bundle being located on different data storage devices;
generating, by the one or more processors, a lookup table representing a mapping between a logical location of each logical block in the bundle and a physical location of the respective logical block on the corresponding data storage device;
electronically writing, by the one or more processors, data to the physical locations of each logical block in the bundle, the physical locations being obtained from the lookup table;
determining, by the one or more processors, a candidate logical block among all of the logical blocks based at least in part on a speed of a different data storage device and an average access interval of the logical block on the different data storage device; and
electronically writing, by the one or more processors, the data in the candidate logical block to another logical block on the different one of the data storage devices.
